(19) United States
(12) Patent Application Publication
(10) Pub. No.: US 2026/0019562 A1
(43) Pub. Date: Jan. 15, 2026

(54) DECODER SIDE GRADIENT-BASED INTRA MODE DERIVATION ON NON-ADJACENT REFERENCE LINE FOR CHROMA COMPONENTS

(71) Applicant: Tencent America LLC, Palo Alto, CA (US)

(72) Inventors: Biao Wang, Palo Alto, CA (US); Roman Chernyak, Palo Alto, CA (US); Yonguk Yoon, Palo Alto, CA (US); Lien-fei Chen, Palo Alto, CA (US); Ziyue Xiang, Palo Alto, CA (US); Yifan Wang, Palo Alto, CA (US); Motong Xu, Palo Alto, CA (US); Shan Liu, Palo Alto, CA (US)

(21) Appl. No.: 19/266,054

(22) Filed: Jul. 10, 2025

Related U.S. Application Data
(60) Provisional application No. 63/671,179, filed on Jul. 13, 2024.
(60) Provisional application No. 63/673,127, filed on Jul. 18, 2024.

(51) Int. Cl. H04N 19/105; H04N 19/117; H04N 19/159; H04N 19/176; H04N 19/82

(52) U.S. Cl. CPC H04N 19/105; H04N 19/117; H04N 19/159; H04N 19/176; H04N 19/82

(57) ABSTRACT

An example method of video decoding includes receiving a video bitstream comprising a plurality of blocks, including a current block. For each reference line of a plurality of reference lines for the current block: the method includes identifying a respective reference area corresponding to the reference line; and identifying a respective set of intra prediction modes by performing a gradient-based intra mode derivation on the respective reference area. The method includes populating a list of intra mode and reference line combinations using respective intra prediction modes from each respective set of intra prediction modes and a respective reference area according to a corresponding reference line; selecting an intra prediction mode and a reference line from the list of intra mode and reference line combinations; and decoding the current block using the intra prediction mode.

### RELATED APPLICATIONS

This application claims priority to U.S. Provisional Patent Application No. 63/671,179 entitled “Decoder Side gradient-based Intra Mode Derivation on Non-adjacent Reference Line for Chroma Components,” filed Jul. 13, 2024, and to U.S. Provisional Patent Application No. 63/673,127 entitled “Intra Mode Derivation using a Simplified Edge Filter when Non-Conventional Intra Predictor is Used,” filed Jul. 18, 2024, which are hereby incorporated by reference in their entirety.

### TECHNICAL FIELD

The disclosed embodiments relate generally to video coding, including but not limited to systems and methods for edge filtering and intra mode derivations.

### BACKGROUND

Digital video is supported by a variety of electronic devices, such as digital televisions, laptop or desktop computers, tablet computers, digital cameras, digital recording devices, digital media players, video gaming consoles, smart phones, video teleconferencing devices, video streaming devices, etc. The electronic devices transmit and receive or otherwise communicate digital video data across a communication network, and/or store the digital video data on a storage device. Due to a limited bandwidth capacity of the communication network and limited memory resources of the storage device, video coding may be used to compress the video data according to one or more video coding standards before it is communicated or stored. The video coding can be performed by hardware and/or software on an electronic/client device or a server providing a cloud service.

Video coding generally utilizes prediction methods (e.g., inter-prediction, intra-prediction, or the like) that take advantage of redundancy inherent in the video data. Video coding aims to compress video data into a form that uses a lower bit rate, while avoiding or minimizing degradations to video quality. Multiple video codec standards have been developed. For example, High-Efficiency Video Coding (HEVC/H.265) is a video compression standard designed as part of the MPEG-H project. ITU-T and ISO/IEC published the HEVC/H.265 standard in 2013 (version 1), 2014 (version 2), 2015 (version 3), and 2016 (version 4). Versatile Video Coding (VVC/H.266) is a video compression standard intended as a successor to HEVC. ITU-T and ISO/IEC published the VVC/H.266 standard in 2020 (version 1) and 2022 (version 2). AOMedia Video 1 (AV1) is an open video coding format designed as an alternative to HEVC. On Jan. 8, 2019, a validated version 1.0.0 with Errata 1 of the specification was released. Enhanced Compression Model (ECM) is a video coding standard that is currently under development. ECM aims to significantly improve compression efficiency beyond existing standards like HEVC/H.265 and VVC, essentially allowing for higher quality video at lower bitrates.

### SUMMARY

The present disclosure describes a set of methods for video (image) compression, including methods of gradient-based intra mode derivation. For example, multiple reference lines may be used for decoder side gradient-based mode derivation with template cost-based intra prediction. An example method includes, for each reference line of a plurality of reference lines for the current block, identifying a respective set of intra prediction modes by performing a gradient-based intra mode derivation on a corresponding reference area. Using a different intra prediction mode for each reference line allows for adaptivity and provides more diversity, which improves coding efficiency.

In accordance with some embodiments, a method of video decoding includes (i) receiving a video bitstream (e.g., a coded video sequence) comprising a plurality of blocks, including a current block; (ii) for each reference line of a plurality of reference lines for the current block: (a) identifying a respective reference area corresponding to the reference line and (b) identifying a respective set of intra prediction modes by performing a gradient-based intra mode derivation on the respective reference area; (iii) populating a list of intra mode and reference line combinations using respective intra prediction modes from each respective set of intra prediction modes and a respective reference area according to a corresponding reference line; (iv) selecting an intra prediction mode and a reference line from the list of intra mode and reference line combinations; and (v) decoding the current block using the intra prediction mode.

In accordance with some embodiments, a method of video encoding includes (i) receiving video data (e.g., a source video sequence) comprising a plurality of blocks, including a current block; (ii) for each reference line of a plurality of reference lines for the current block: (a) identifying a respective reference area corresponding to the reference line and (b) identifying a respective set of intra prediction modes by performing a gradient-based intra mode derivation on the respective reference area; (iii) populating a list of intra mode and reference line combinations using respective intra prediction modes from each respective set of intra prediction modes and a respective reference area according to a corresponding reference line; (iv) selecting an intra prediction mode and a reference line from the list of intra mode and reference line combinations; and (v) encoding the current block using the intra prediction mode.

In accordance with some embodiments, a method of video decoding includes (i) receiving a video bitstream (e.g., a coded video sequence) a plurality of blocks, including a current block; (ii) identifying a reference area for the current block; (iii) identifying a set of intra prediction modes by performing a gradient-based intra mode derivation on the reference area, including applying an edge filter to reference samples of the reference area; (iv) selecting an intra prediction mode from the set of intra prediction modes; and (v) decoding the current block using the intra prediction mode.

In accordance with some embodiments, a computing system is provided, such as a streaming system, a server system, a personal computer system, or other electronic device. The computing system includes control circuitry and memory storing one or more sets of instructions. The one or more sets of instructions including instructions for performing any of the methods described herein. In some embodiments, the computing system includes an encoder component and a decoder component (e.g., a transcoder).

In accordance with some embodiments, a non-transitory computer-readable storage medium is provided. The non-transitory computer-readable storage medium stores one or more sets of instructions for execution by a computing system. The one or more sets of instructions including instructions for performing any of the methods described herein.

Thus, devices and systems are disclosed with methods for encoding and decoding video. Such methods, devices, and systems may complement or replace conventional methods, devices, and systems for video encoding/decoding. The features and advantages described in the specification are not necessarily all-inclusive and, in particular, some additional features and advantages will be apparent to one of ordinary skill in the art in view of the drawings, specification, and claims provided in this disclosure. Moreover, it should be noted that the language used in the specification has been principally selected for readability and instructional purposes and has not necessarily been selected to delineate or circumscribe the subject matter described herein.

### BRIEF DESCRIPTION OF THE DRAWINGS

So that the present disclosure can be understood in greater detail, a more particular description can be had by reference to the features of various embodiments, some of which are illustrated in the appended drawings. The appended drawings, however, merely illustrate pertinent features of the present disclosure and are therefore not necessarily to be considered limiting, for the description can admit to other effective features as the person of skill in this art will appreciate upon reading this disclosure.

FIG. 1 is a block diagram illustrating an example communication system in accordance with some embodiments.

FIG. 2A is a block diagram illustrating example elements of an encoder component in accordance with some embodiments.

FIG. 2B is a block diagram illustrating example elements of a decoder component in accordance with some embodiments.

FIG. 3 is a block diagram illustrating an example server system in accordance with some embodiments.

FIG. 4A illustrates using a template to derive an intra prediction mode in accordance with some embodiments.

FIG. 4B illustrates an example of decoder-side gradient based intra mode derivation in accordance with some embodiments.

FIG. 4C illustrates the use of multiple reference line in accordance with some embodiments.

FIG. 5A illustrates an example decoder-side gradient-based intra mode derivation applied on both adjacent template and non-adjacent templates in accordance with some embodiments.

FIG. 5B illustrates an example extended template in accordance with some embodiments.

FIG. 6A illustrates various directional intra prediction modes in accordance with some embodiments.

FIGS. 6B-6G illustrate the use of different window sizes for constructing histograms in accordance with some embodiments.

FIG. 7A illustrates an example video decoding process in accordance with some embodiments.

FIG. 7B illustrates an example video encoding process in accordance with some embodiments.

In accordance with common practice, the various features illustrated in the drawings are not necessarily drawn to scale, and like reference numerals can be used to denote like features throughout the specification and figures.

### DETAILED DESCRIPTION

The present disclosure describes a set of methods for video (image) compression, including methods of gradient-based intra prediction mode derivation. For example, one or more edge filters may be used in a gradient-based intra mode derivation method to derive a conventional intra prediction mode when a non-conventional intra prediction mode is applied for the prediction of the current block. Improving the derivation method can improve coding efficiency as a more accurate prediction can be identified for the video block. As another example, a unified predefined intra mode list may be constructed using multiple reference lines. For example, a gradient-based intra mode derivation may be performed for each of the multiple reference lines. Constructing a mode list in this manner can improve the list diversity, which increases the coding efficiency, e.g., by including more accurate modes to be selected from the list.

### Example Systems and Devices

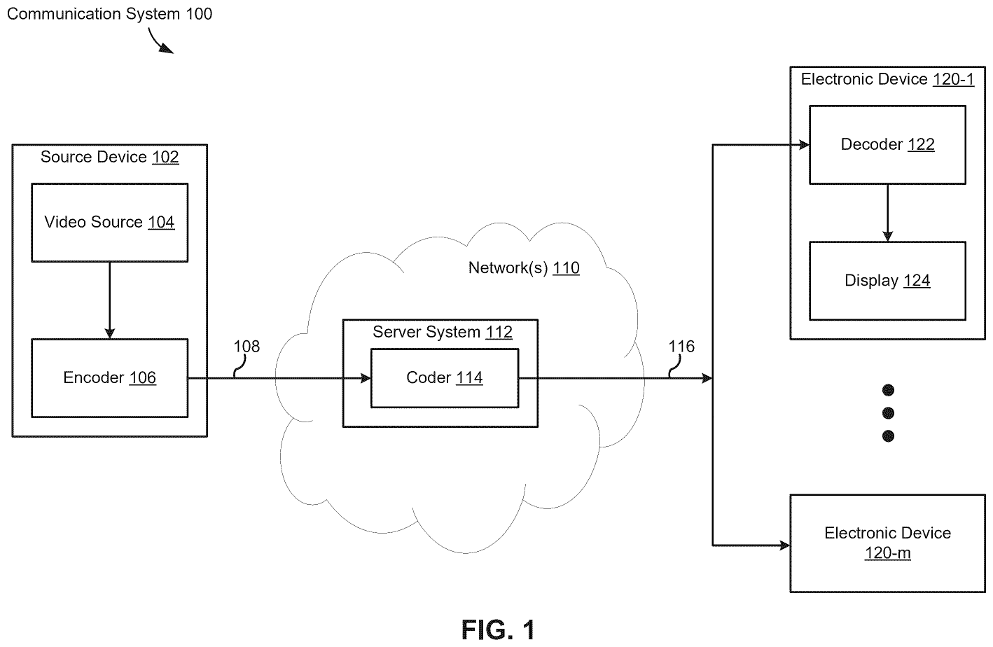

FIG. 1 is a block diagram illustrating a communication system 100 in accordance with some embodiments. The communication system 100 includes a source device 102 and a plurality of electronic devices 120 (e.g., electronic device 120-1 to electronic device 120-m) that are communicatively coupled to one another via one or more networks. In some embodiments, the communication system 100 is a streaming system, e.g., for use with video-enabled applications such as video conferencing applications, digital TV applications, and media storage and/or distribution applications.

The source device 102 includes a video source 104 (e.g., a camera component or media storage) and an encoder component 106. In some embodiments, the video source 104 is a digital camera (e.g., configured to create an uncompressed video sample stream). The encoder component 106 generates one or more encoded video bitstreams from the video stream. The video stream from the video source 104 may be high data volume as compared to the encoded video bitstream 108 generated by the encoder component 106. Because the encoded video bitstream 108 is lower data volume (less data) as compared to the video stream from the video source, the encoded video bitstream 108 requires less bandwidth to transmit and less storage space to store as compared to the video stream from the video source 104. In some embodiments, the source device 102 does not include the encoder component 106 (e.g., is configured to transmit uncompressed video to the network(s) 110).

The one or more networks 110 represents any number of networks that convey information between the source device 102, the server system 112, and/or the electronic devices 120, including, e.g., wireline (wired) and/or wireless communication networks. The one or more networks 110 may exchange data in circuit-switched and/or packet-switched channels. Representative networks include telecommunications networks, local area networks, wide area networks and/or the Internet.

The one or more networks 110 include a server system 112 (e.g., a distributed/cloud computing system). In some embodiments, the server system 112 is, or includes, a streaming server (e.g., configured to store and/or distribute video content such as the encoded video stream from the source device 102). The server system 112 includes a coder component 114 (e.g., configured to encode and/or decode video data). In some embodiments, the coder component 114 includes an encoder component and/or a decoder component. In various embodiments, the coder component 114 is instantiated as hardware, software, or a combination thereof. In some embodiments, the coder component 114 is configured to decode the encoded video bitstream 108 and re-encode the video data using a different encoding standard and/or methodology to generate encoded video data 116. In some embodiments, the server system 112 is configured to generate multiple video formats and/or encodings from the encoded video bitstream 108. In some embodiments, the server system 112 functions as a Media-Aware Network Element (MANE). For example, the server system 112 may be configured to prune the encoded video bitstream 108 for tailoring potentially different bitstreams to one or more of the electronic devices 120. In some embodiments, a MANE is provided separate from the server system 112.

The electronic device 120-1 includes a decoder component 122 and a display 124. In some embodiments, the decoder component 122 is configured to decode the encoded video data 116 to generate an outgoing video stream that can be rendered on a display or other type of rendering device. In some embodiments, one or more of the electronic devices 120 does not include a display component (e.g., is communicatively coupled to an external display device and/or includes a media storage). In some embodiments, the electronic devices 120 are streaming clients. In some embodiments, the electronic devices 120 are configured to access the server system 112 to obtain the encoded video data 116. In some embodiments, the source device 102 and/or one or more of the electronic devices 120 are instances of a server system, a personal computer, a portable device (e.g., a smartphone, tablet, or laptop), a wearable device, a video conferencing device, and/or other type of electronic device.

In example operation of the communication system 100, the source device 102 transmits the encoded video bitstream 108 to the server system 112. For example, the source device 102 may code a stream of pictures that are captured by the source device. The server system 112 receives the encoded video bitstream 108 and may decode and/or encode the encoded video bitstream 108 using the coder component 114. For example, the server system 112 may apply an encoding to the video data that is more optimal for network transmission and/or storage. The server system 112 may transmit the encoded video data 116 (e.g., one or more coded video bitstreams) to one or more of the electronic devices 120. Each electronic device 120 may decode the encoded video data 116 and optionally display the video pictures.

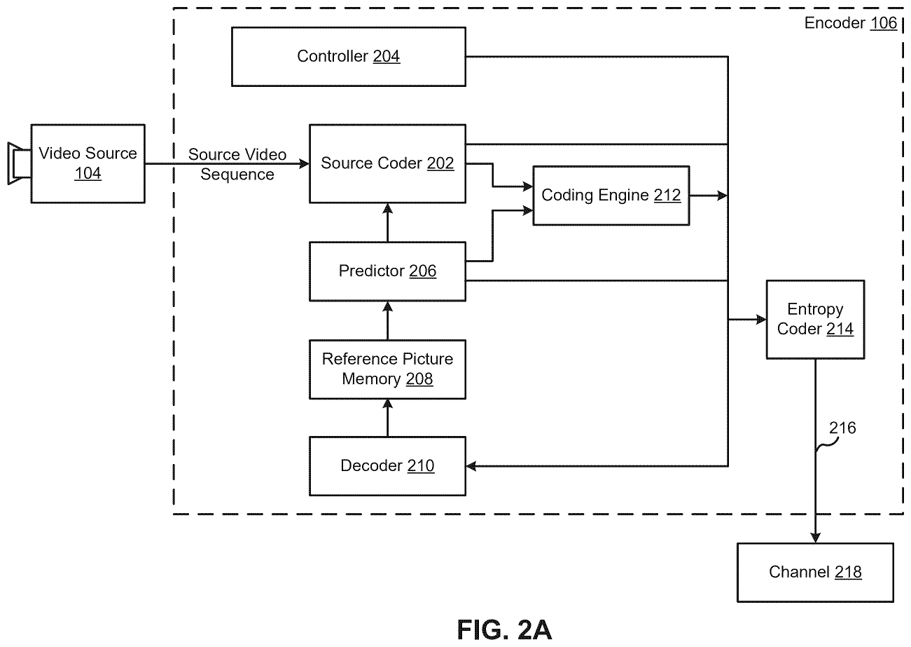

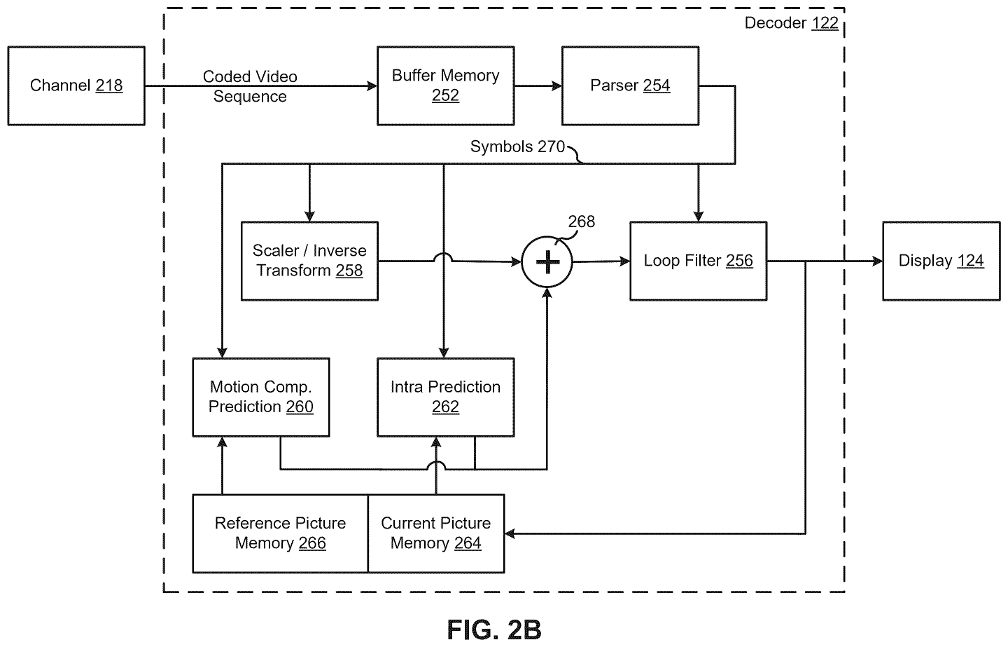

FIG. 2A is a block diagram illustrating example elements of the encoder component 106 in accordance with some embodiments. The encoder component 106 receives video data (e.g., a source video sequence) from the video source 104. In some embodiments, the encoder component includes a receiver (e.g., a transceiver) component configured to receive the source video sequence. In some embodiments, the encoder component 106 receives a video sequence from a remote video source (e.g., a video source that is a component of a different device than the encoder component 106). The video source 104 may provide the source video sequence in the form of a digital video sample stream that can be of any suitable bit depth (e.g., 8-bit, 10-bit, or 12-bit), any colorspace (e.g., BT.601 Y CrCB, or RGB), and any suitable sampling structure (e.g., Y CrCb 4:2:0 or Y CrCb 4:4:4). In some embodiments, the video source 104 is a storage device storing previously captured/prepared video. In some embodiments, the video source 104 is camera that captures local image information as a video sequence. Video data may be provided as a plurality of individual pictures that impart motion when viewed in sequence. The pictures themselves may be organized as a spatial array of pixels, where each pixel can include one or more samples depending on the sampling structure, color space, etc. in use. A person of ordinary skill in the art can readily understand the relationship between pixels and samples.

The encoder component 106 is configured to code and/or compress the pictures of the source video sequence into a coded video sequence 216 in real-time or under other time constraints as required by the application. In some embodiments, the encoder component 106 is configured to perform a conversion between the source video sequence and a bitstream of visual media data (e.g., a video bitstream). Enforcing appropriate coding speed is one function of a controller 204. In some embodiments, the controller 204 controls other functional units as described below and is functionally coupled to the other functional units. Parameters set by the controller 204 may include rate-control-related parameters (e.g., picture skip, quantizer, and/or lambda value of rate-distortion optimization techniques), picture size, group of pictures (GOP) layout, maximum motion vector search range, and so forth. A person of ordinary skill in the art can readily identify other functions of controller 204 as they may pertain to the encoder component 106 being optimized for a certain system design.

In some embodiments, the encoder component 106 is configured to operate in a coding loop. In a simplified example, the coding loop includes a source coder 202 (e.g., responsible for creating symbols, such as a symbol stream, based on an input picture to be coded and reference picture(s)), and a (local) decoder 210. The decoder 210 reconstructs the symbols to create the sample data in a similar manner as a (remote) decoder (when compression between symbols and coded video bitstream is lossless). The reconstructed sample stream (sample data) is input to the reference picture memory 208. As the decoding of a symbol stream leads to bit-exact results independent of decoder location (local or remote), the content in the reference picture memory 208 is also bit exact between the local encoder and remote encoder. In this way, the prediction part of an encoder interprets as reference picture samples the same sample values as a decoder would interpret when using prediction during decoding.

The operation of the decoder 210 can be the same as of a remote decoder, such as the decoder component 122, which is described in detail below in conjunction with FIG. 2B. Briefly referring to FIG. 2B, however, as symbols are available and encoding/decoding of symbols to a coded video sequence by an entropy coder 214 and the parser 254 can be lossless, the entropy decoding parts of the decoder component 122, including the buffer memory 252 and the parser 254 may not be fully implemented in the local decoder 210.

The decoder technology described herein, except the parsing/entropy decoding, may be to be present, in substantially identical functional form, in a corresponding encoder. For this reason, the disclosed subject matter focuses on decoder operation. Additionally, the description of encoder technologies can be abbreviated as they may be the inverse of the decoder technologies.

As part of its operation, the source coder 202 may perform motion compensated predictive coding, which codes an input frame predictively with reference to one or more previously-coded frames from the video sequence that were designated as reference frames. In this manner, the coding engine 212 codes differences between pixel blocks of an input frame and pixel blocks of reference frame(s) that may be selected as prediction reference(s) to the input frame. The controller 204 may manage coding operations of the source coder 202, including, e.g., setting of parameters and subgroup parameters used for encoding the video data.

The decoder 210 decodes coded video data of frames that may be designated as reference frames, based on symbols created by the source coder 202. Operations of the coding engine 212 may advantageously be lossy processes. When the coded video data is decoded at a video decoder (not shown in FIG. 2A), the reconstructed video sequence may be a replica of the source video sequence with some errors. The decoder 210 replicates decoding processes that may be performed by a remote video decoder on reference frames and may cause reconstructed reference frames to be stored in the reference picture memory 208. In this manner, the encoder component 106 stores copies of reconstructed reference frames locally that have common content as the reconstructed reference frames that will be obtained by a remote video decoder (absent transmission errors).

The predictor 206 may perform prediction searches for the coding engine 212. That is, for a new frame to be coded, the predictor 206 may search the reference picture memory 208 for sample data (as candidate reference pixel blocks) or certain metadata such as reference picture motion vectors, block shapes, and so on, that may serve as an appropriate prediction reference for the new pictures. The predictor 206 may operate on a sample block-by-pixel block basis to find appropriate prediction references. As determined by search results obtained by the predictor 206, an input picture may have prediction references drawn from multiple reference pictures stored in the reference picture memory 208.

Output of all aforementioned functional units may be subjected to entropy coding in the entropy coder 214. The entropy coder 214 translates the symbols as generated by the various functional units into a coded video sequence, by losslessly compressing the symbols according to technologies known to a person of ordinary skill in the art (e.g., Huffman coding, variable length coding, and/or arithmetic coding).

In some embodiments, an output of the entropy coder 214 is coupled to a transmitter. The transmitter may be configured to buffer the coded video sequence(s) as created by the entropy coder 214 to prepare them for transmission via a communication channel 218, which may be a hardware/software link to a storage device which would store the encoded video data. The transmitter may be configured to merge coded video data from the source coder 202 with other data to be transmitted, for example, coded audio data and/or ancillary data streams (sources not shown). In some embodiments, the transmitter may transmit additional data with the encoded video. The source coder 202 may include such data as part of the coded video sequence. Additional data may comprise temporal/spatial/SNR enhancement layers, other forms of redundant data such as redundant pictures and slices, Supplementary Enhancement Information (SEI) messages, Visual Usability Information (VUI) parameter set fragments, and the like.

The controller 204 may manage operation of the encoder component 106. During coding, the controller 204 may assign to each coded picture a certain coded picture type, which may affect the coding techniques that are applied to the respective picture. For example, pictures may be assigned as an Intra Picture (I picture), a Predictive Picture (P picture), or a Bi-directionally Predictive Picture (B Picture). An Intra Picture may be coded and decoded without using any other frame in the sequence as a source of prediction. Some video codecs allow for different types of Intra pictures, including, for example Independent Decoder Refresh (IDR) Pictures. A person of ordinary skill in the art is aware of those variants of I pictures and their respective applications and features, and therefore they are not repeated here. A Predictive picture may be coded and decoded using intra prediction or inter prediction using at most one motion vector and reference index to predict the sample values of each block. A Bi-directionally Predictive Picture may be coded and decoded using intra prediction or inter prediction using at most two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (e.g., blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded non-predictively, via spatial prediction or via temporal prediction with reference to one previously coded reference pictures. Blocks of B pictures may be coded non-predictively, via spatial prediction or via temporal prediction with reference to one or two previously coded reference pictures.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

The encoder component 106 may perform coding operations according to a predetermined video coding technology or standard, such as any described herein. In its operation, the encoder component 106 may perform various compression operations, including predictive coding operations that exploit temporal and spatial redundancies in the input video sequence. The coded video data, therefore, may conform to a syntax specified by the video coding technology or standard being used.

FIG. 2B is a block diagram illustrating example elements of the decoder component 122 in accordance with some embodiments. The decoder component 122 in FIG. 2B is coupled to the channel 218 and the display 124. In some embodiments, the decoder component 122 includes a transmitter coupled to the loop filter 256 and configured to transmit data to the display 124 (e.g., via a wired or wireless connection).

In some embodiments, the decoder component 122 includes a receiver coupled to the channel 218 and configured to receive data from the channel 218 (e.g., via a wired or wireless connection). The receiver may be configured to receive one or more coded video sequences to be decoded by the decoder component 122. In some embodiments, the decoding of each coded video sequence is independent from other coded video sequences. Each coded video sequence may be received from the channel 218, which may be a hardware/software link to a storage device which stores the encoded video data. The receiver may receive the encoded video data with other data, e.g., coded audio data and/or ancillary data streams, that may be forwarded to their respective using entities (not depicted). The receiver may separate the coded video sequence from the other data. In some embodiments, the receiver receives additional (redundant) data with the encoded video. The additional data may be included as part of the coded video sequence(s). The additional data may be used by the decoder component 122 to decode the data and/or to more accurately reconstruct the original video data. Additional data can be in the form of, e.g., temporal, spatial, or SNR enhancement layers, redundant slices, redundant pictures, forward error correction codes, and so on.

In accordance with some embodiments, the decoder component 122 includes a buffer memory 252, a parser 254 (also sometimes referred to as an entropy decoder), a scaler/inverse transform unit 258, an intra picture prediction unit 262, a motion compensation prediction unit 260, an aggregator 268, the loop filter unit 256, a reference picture memory 266, and a current picture memory 264. In some embodiments, the decoder component 122 is implemented as an integrated circuit, a series of integrated circuits, and/or other electronic circuitry. The decoder component 122 may be implemented at least in part in software.

The buffer memory 252 is coupled in between the channel 218 and the parser 254 (e.g., to combat network jitter). In some embodiments, the buffer memory 252 is separate from the decoder component 122. In some embodiments, a separate buffer memory is provided between the output of the channel 218 and the decoder component 122. In some embodiments, a separate buffer memory is provided outside of the decoder component 122 (e.g., to combat network jitter) in addition to the buffer memory 252 inside the decoder component 122 (e.g., which is configured to handle playout timing). When receiving data from a store/forward device of sufficient bandwidth and controllability, or from an isosynchronous network, the buffer memory 252 may not be needed, or can be small. For use on best effort packet networks such as the Internet, the buffer memory 252 may be required, can be comparatively large and/or of adaptive size, and may at least partially be implemented in an operating system or similar elements outside of the decoder component 122.

The parser 254 is configured to reconstruct symbols 270 from the coded video sequence. The symbols may include, e.g., information used to manage operation of the decoder component 122, and/or information to control a rendering device such as the display 124. The control information for the rendering device(s) may be in the form of, e.g., Supplementary Enhancement Information (SEI) messages or Video Usability Information (VUI) parameter set fragments (not depicted). The parser 254 parses (entropy-decodes) the coded video sequence. The coding of the coded video sequence can be in accordance with a video coding technology or standard, and can follow principles well known to a person skilled in the art, including variable length coding, Huffman coding, arithmetic coding with or without context sensitivity, and so forth. The parser 254 may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser 254 may also extract, from the coded video sequence, information such as transform coefficients, quantizer parameter values, motion vectors, and so forth.

Reconstruction of the symbols 270 can involve multiple different units depending on the type of the coded video picture or parts thereof (such as: inter and intra picture, inter and intra block), and other factors. Which units are involved, and how they are involved, can be controlled by the subgroup control information that was parsed from the coded video sequence by the parser 254. The flow of such subgroup control information between the parser 254 and the multiple units below is not depicted for clarity.

The decoder component 122 can be conceptually subdivided into a number of functional units, and in some implementations, these units interact closely with each other and can, at least partly, be integrated into each other. However, for clarity, the conceptual subdivision of the functional units is maintained herein.

The scaler/inverse transform unit 258 receives quantized transform coefficients as well as control information (such as which transform to use, block size, quantization factor, and/or quantization scaling matrices) as symbol(s) 270 from the parser 254. The scaler/inverse transform unit 258 can output blocks including sample values that can be input into the aggregator 268. In some cases, the output samples of the scaler/inverse transform unit 258 pertain to an intra coded block; that is: a block that is not using predictive information from previously reconstructed pictures, but can use predictive information from previously reconstructed parts of the current picture. Such predictive information can be provided by the intra picture prediction unit 262. The intra picture prediction unit 262 may generate a block of the same size and shape as the block under reconstruction, using surrounding already-reconstructed information fetched from the current (partly reconstructed) picture from the current picture memory 264. The aggregator 268 may add, on a per sample basis, the prediction information the intra picture prediction unit 262 has generated to the output sample information as provided by the scaler/inverse transform unit 258.

In other cases, the output samples of the scaler/inverse transform unit 258 pertain to an inter coded, and potentially motion-compensated, block. In such cases, the motion compensation prediction unit 260 can access the reference picture memory 266 to fetch samples used for prediction. After motion compensating the fetched samples in accordance with the symbols 270 pertaining to the block, these samples can be added by the aggregator 268 to the output of the scaler/inverse transform unit 258 (in this case called the residual samples or residual signal) so to generate output sample information. The addresses within the reference picture memory 266, from which the motion compensation prediction unit 260 fetches prediction samples, may be controlled by motion vectors. The motion vectors may be available to the motion compensation prediction unit 260 in the form of symbols 270 that can have, e.g., X, Y, and reference picture components. Motion compensation may also include interpolation of sample values as fetched from the reference picture memory 266, e.g., when sub-sample exact motion vectors are in use, motion vector prediction mechanisms.

The output samples of the aggregator 268 can be subject to various loop filtering techniques in the loop filter unit 256. Video compression technologies can include in-loop filter technologies that are controlled by parameters included in the coded video bitstream and made available to the loop filter unit 256 as symbols 270 from the parser 254, but can also be responsive to meta-information obtained during the decoding of previous (in decoding order) parts of the coded picture or coded video sequence, as well as responsive to previously reconstructed and loop-filtered sample values. The output of the loop filter unit 256 can be a sample stream that can be output to a render device such as the display 124, as well as stored in the reference picture memory 266 for use in future inter-picture prediction.

Certain coded pictures, once reconstructed, can be used as reference pictures for future prediction. Once a coded picture is reconstructed and the coded picture has been identified as a reference picture (e.g., by parser 254), the current reference picture can become part of the reference picture memory 266, and a fresh current picture memory can be reallocated before commencing the reconstruction of the following coded picture.

The decoder component 122 may perform decoding operations according to a predetermined video compression technology that may be documented in a standard, such as any of the standards described herein. The coded video sequence may conform to a syntax specified by the video compression technology or standard being used, in the sense that it adheres to the syntax of the video compression technology or standard, as specified in the video compression technology document or standard and specifically in the profiles document therein. Also, for compliance with some video compression technologies or standards, the complexity of the coded video sequence may be within bounds as defined by the level of the video compression technology or standard. Levels may restrict the maximum picture size, maximum frame rate, maximum reconstruction sample rate (measured in, e.g., megasamples per second), maximum reference picture size, and so on. Limits set by levels may be further restricted through Hypothetical Reference Decoder (HRD) specifications and metadata for HRD buffer management signaled in the coded video sequence.

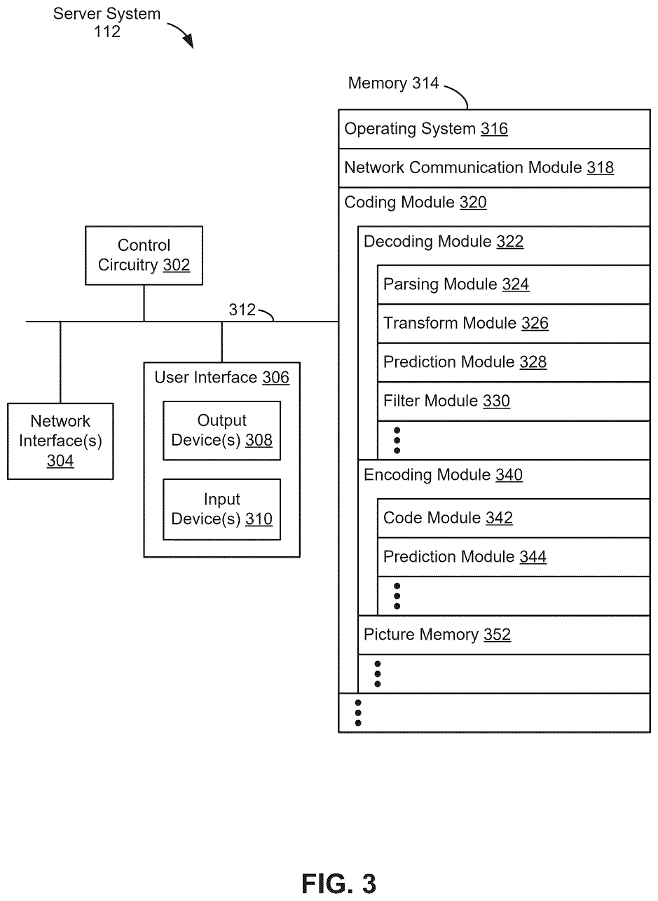

FIG. 3 is a block diagram illustrating the server system 112 in accordance with some embodiments. The server system 112 includes control circuitry 302, one or more network interfaces 304, a memory 314, a user interface 306, and one or more communication buses 312 for interconnecting these components. In some embodiments, the control circuitry 302 includes one or more processors (e.g., a CPU, GPU, and/or DPU). In some embodiments, the control circuitry includes field-programmable gate array(s), hardware accelerators, and/or integrated circuit(s) (e.g., an application-specific integrated circuit).

The network interface(s) 304 may be configured to interface with one or more communication networks (e.g., wireless, wireline, and/or optical networks). The communication networks can be local, wide-area, metropolitan, vehicular and industrial, real-time, delay-tolerant, and so on. Examples of communication networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Such communication can be unidirectional, receive only (e.g., broadcast TV), unidirectional send-only (e.g., CANbus to certain CANbus devices), or bi-directional (e.g., to other computer systems using local or wide area digital networks). Such communication can include communication to one or more cloud computing networks.

The user interface 306 includes one or more output devices 308 and/or one or more input devices 310. The input device(s) 310 may include one or more of: a keyboard, a mouse, a trackpad, a touch screen, a data-glove, a joystick, a microphone, a scanner, a camera, or the like. The output device(s) 308 may include one or more of: an audio output device (e.g., a speaker), a visual output device (e.g., a display or monitor), or the like.

The memory 314 may include high-speed random-access memory (such as DRAM, SRAM, DDR RAM, and/or other random access solid-state memory devices) and/or non-volatile memory (such as one or more magnetic disk storage devices, optical disk storage devices, flash memory devices, and/or other non-volatile solid-state storage devices). The memory 314 optionally includes one or more storage devices remotely located from the control circuitry 302. The memory 314, or, alternatively, the non-volatile solid-state memory device(s) within the memory 314, includes a non-transitory computer-readable storage medium. In some embodiments, the memory 314, or the non-transitory computer-readable storage medium of the memory 314, stores the following programs, modules, instructions, and data structures, or a subset or superset thereof:
an operating system 316 that includes procedures for handling various basic system services and for performing hardware-dependent tasks;
a network communication module 318 that is used for connecting the server system 112 to other computing devices via the one or more network interfaces 304 (e.g., via wired and/or wireless connections);
a coding module 320 for performing various functions with respect to encoding and/or decoding data, such as video data. In some embodiments, the coding module 320 is an instance of the coder component 114. The coding module 320 including, but not limited to, one or more of:
   a decoding module 322 for performing various functions with respect to decoding encoded data, such as those described previously with respect to the decoder component 122; and
   an encoding module 340 for performing various functions with respect to encoding data, such as those described previously with respect to the encoder component 106; and
a picture memory 352 for storing pictures and picture data, e.g., for use with the coding module 320. In some embodiments, the picture memory 352 includes one or more of: the reference picture memory 208, the buffer memory 252, the current picture memory 264, and the reference picture memory 266.

In some embodiments, the decoding module 322 includes a parsing module 324 (e.g., configured to perform the various functions described previously with respect to the parser 254), a transform module 326 (e.g., configured to perform the various functions described previously with respect to the scalar/inverse transform unit 258), a prediction module 328 (e.g., configured to perform the various functions described previously with respect to the motion compensation prediction unit 260 and/or the intra picture prediction unit 262), and a filter module 330 (e.g., configured to perform the various functions described previously with respect to the loop filter 256).

In some embodiments, the encoding module 340 includes a code module 342 (e.g., configured to perform the various functions described previously with respect to the source coder 202 and/or the coding engine 212) and a prediction module 344 (e.g., configured to perform the various functions described previously with respect to the predictor 206). In some embodiments, the decoding module 322 and/or the encoding module 340 include a subset of the modules shown in FIG. 3. For example, a shared prediction module is used by both the decoding module 322 and the encoding module 340.

Each of the above identified modules stored in the memory 314 corresponds to a set of instructions for performing a function described herein. The above identified modules (e.g., sets of instructions) need not be implemented as separate software programs, procedures, or modules, and thus various subsets of these modules may be combined or otherwise re-arranged in various embodiments. For example, the coding module 320 optionally does not include separate decoding and encoding modules, but rather uses a same set of modules for performing both sets of functions. In some embodiments, the memory 314 stores a subset of the modules and data structures identified above. In some embodiments, the memory 314 stores additional modules and data structures not described above.

Although FIG. 3 illustrates the server system 112 in accordance with some embodiments, FIG. 3 is intended more as a functional description of the various features that may be present in one or more server systems rather than a structural schematic of the embodiments described herein. In practice, items shown separately could be combined and some items could be separated. For example, some items shown separately in FIG. 3 could be implemented on single servers and single items could be implemented by one or more servers. The actual number of servers used to implement the server system 112, and how features are allocated among them, will vary from one implementation to another and, optionally, depends in part on the amount of data traffic that the server system handles during peak usage periods as well as during average usage periods.

### Example Coding Techniques

The coding processes and techniques described below may be performed at the devices and systems described above (e.g., the source device 102, the server system 112, and/or the electronic device 120). The present disclosure covers decoder side intra prediction mode derivations, e.g., using template cost-based intra prediction with multiple reference lines. The decoder side gradient-based mode derivation process may include populating a combined intra mode list by selecting respective intra prediction modes from each respective set of intra prediction modes. Using different intra prediction mode for each reference line allows for adaptivity and provides more diversity, which provides better coding efficiency.

Several decoder-side intra prediction mode derivation approaches are described, e.g., to reduce signaling overhead, such as template cost-based intra prediction mode derivation and decoder-side gradient based intra prediction mode derivation. A template cost-based intra prediction exploits the fact that if the neighboring samples of current block are well correlated, then a prediction mode works well for the neighboring samples probably would also works well for the current block.

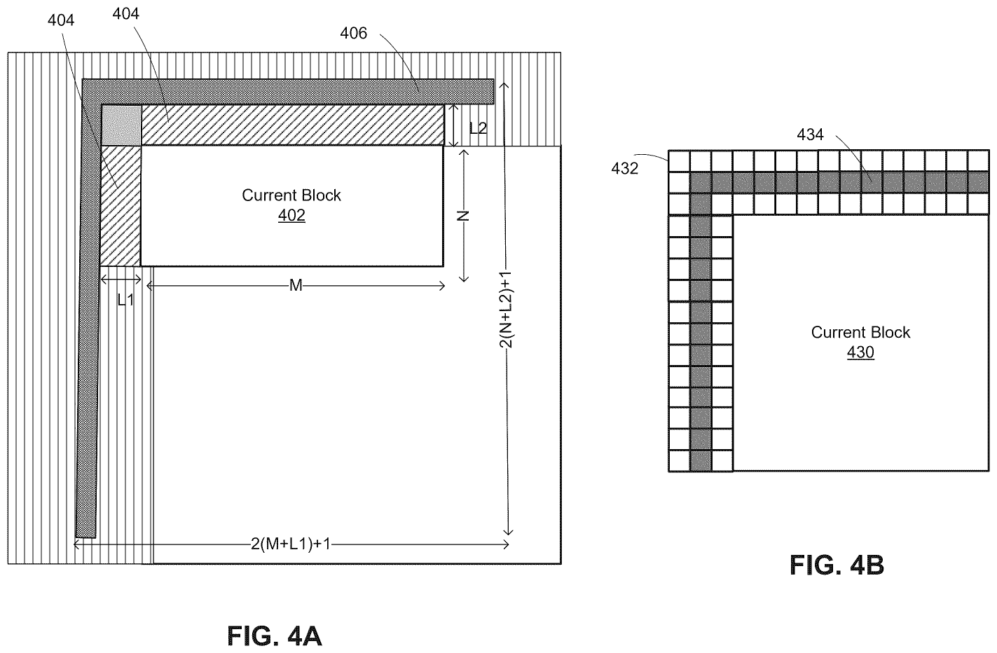

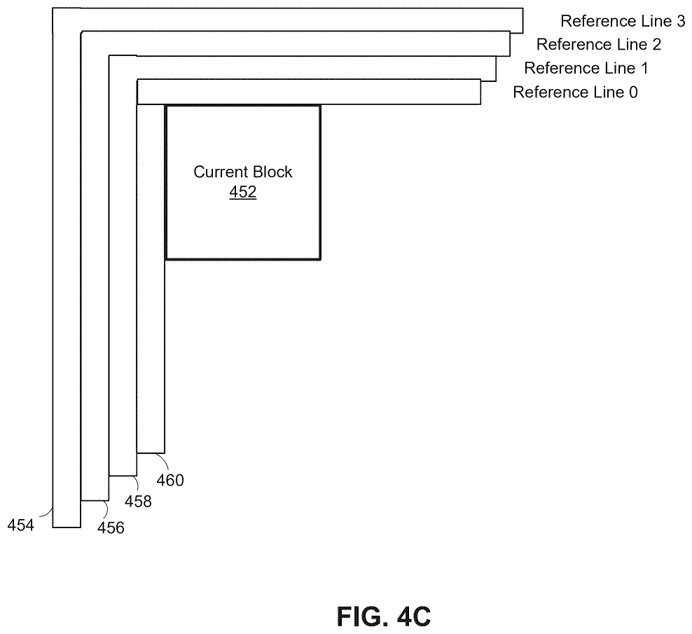

An example intra mode derivation in template cost-based intra prediction includes defining a group of samples 406 as reference of a template 404, as shown in FIG. 4A, and the group of samples 406 is used as reference samples to generate a prediction signal of the template 404. An intra prediction mode is used to generate a prediction of the template 404. The SATD (Sum of Absolute Transformed Differences) cost is calculated between the prediction signal and the reconstruction signal of the template 404. The prediction of the template 404 and the cost between the prediction signal and the reconstruction are repeated for modes in a predefined intra prediction mode set and the predefined intra modes are sorted based on their SATD cost. Such a template cost-based intra prediction is also sometimes referred hereinafter as “method A”. The mode with the least SATD cost is chosen as the prediction mode, or the primary template-based intra mode, for a current block 402. The mode with the second lowest SATD cost is chosen as the secondary prediction mode, or the secondary template-based intra mode, for the current block 402. The SATD costs of non-angular modes (e.g., planar and DC modes) are calculated to select a non-angular mode with the smallest SATD cost as the third prediction mode (e.g., a non-angular prediction mode). Depending on the SATD difference between the primary, secondary and the third non-angular intra modes, the final predictor is: (i) a fusion of predictors from the primary, secondary and the third non-angular intra modes; (ii) a fusion of predictors from the primary and the secondary intra modes; or (iii) solely the primary intra mode without fusion with other intra modes.

Gradient-based intra mode derivation is a statistical based approach that generates a histogram of gradients using adjacent neighboring samples of the current block, sometimes also referred hereinafter as “method B”. Based on the histogram, the top N gradients are mapped to an intra mode, and those predictors are combined to generate a final predictor. In addition, the derived intra prediction modes can be included in a most probable mode candidate list. FIG. 4B shows an example of decoder-side gradient-based intra mode derivation having three lines of neighboring samples (hereinafter also sometimes referred to as a template 432) are considered. The histogram of gradients accounts only for samples in a middle reference line 434, as indicated by the shaded samples in FIG. 4B. The other two neighboring lines (e.g., the higher and lower reference lines) in the template 432 are used to calculate the gradient of the samples in the reference middle line 434.

In some approaches, multiple reference line prediction is combined with template cost-based intra prediction so that a selected reference line is not limited to samples adjacent to a current block 452 (e.g., from reference line 0, or line 460 as shown in FIG. 4C) but non-adjacent reference lines (e.g., reference line 0, reference line 1, reference line 2, reference line 3, corresponding to line 458, line 456, and line 454, respectively) can be chosen that have a non-zero vertical and/or distance from the current block 452. Such a multiple reference line prediction combined with template cost-based intra prediction is also sometimes referred hereinafter as “method C”. FIG. 4C shows samples in four different reference lines 454, 456, 458, and 460 corresponding to the current block (CU). Optionally, more reference lines (e.g., seven, or another number) or fewer reference lines may be used. In some approaches, template cost-based intra prediction is performed for intra modes in a predefined intra mode list, for each reference line in a predefined reference line list to generate, for each entry of a specific reference line and a specific intra mode (e.g., ref₂, mode₂), a SATD cost is calculated using template cost-based intra prediction and the list of entries is sorted based on the SATD cost. Subsequently, one of the first S entries in the sorted list is selected as the intra mode for the current block 452. Table 1 provides an example where the list contains 50 entries at the start. After sorting based on the costs generated from template cost-based intra prediction, a selected number of entries are kept (e.g., S is set to 20 or a different number).

TABLE 1
List of reference lines and intra modes sorted based on costs

| Cost | Reference Line | Intra Mode |
|---|---|---|
| C₀ | ref₀ | mode₀ |
| C₁ | ref ₁ | mode₁ |
| C₂ | ref ₂ | mode₂ |
| . | . | . |
| . | . | . |
| . | . | . |
| C₁₉ | ref ₁₉ | mode₁₉ |
| C₂₀ | ref ₂₀ | mode₂₀ |
| . | . | . |
| . | . | . |
| . | . | . |
| C₄₉ | ref ₄₉ | mode₄₉ |

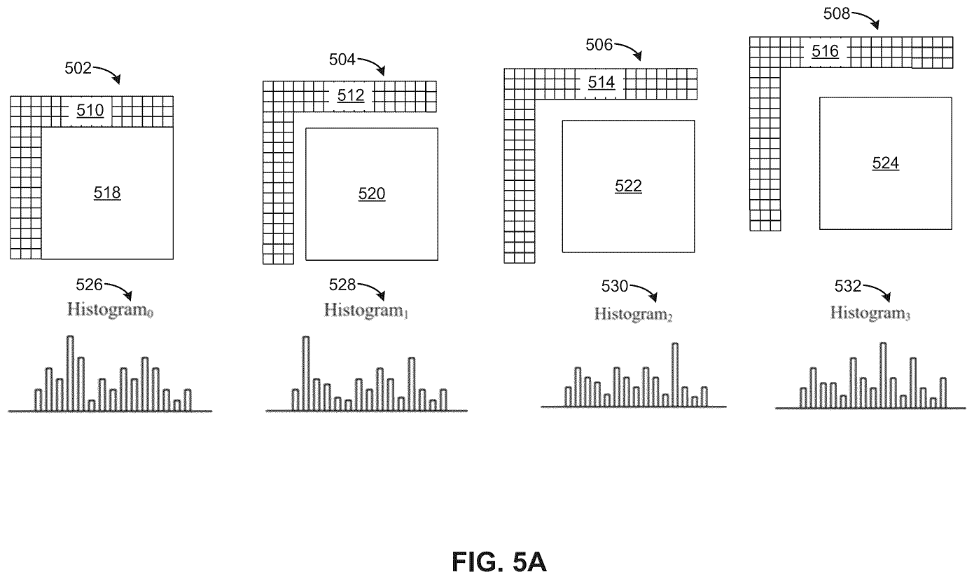

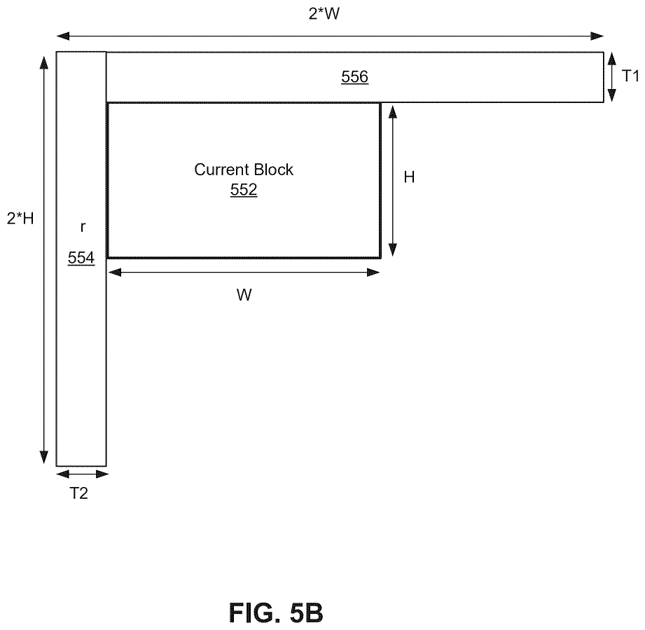

Turning now to example encoding and decoding using multiple reference lines for decoder side gradient-based mode derivation with template cost-based intra prediction, FIG. 5A illustrates the computation of a prediction block in accordance with some embodiments. In the example of FIG. 5A, decoder side gradient-based mode derivation is applied in an example 502 for a reference line index that is equal to zero. In an example 504, an example 506, and an example 508, the reference indices are non-zero. In the example 502, decoder side gradient-based mode derivation is applied on a template 510 that is adjacent the current block 518 and a corresponding histogram 526 (or histogramo) is derived. Similarly, the reference line index for each of the examples 504, 506, and 508 equals to 1, 2, and 3, respectively to generate the respective histograms 528, 530, and 532 (e.g., histogram 1, histogram 2, histogram 3).

As described herein, in some embodiments, decoder side gradient-based mode derivation (e.g., as illustrated in FIG. 4B, or method B) is applied to template cost-based intra prediction with multiple reference lines (e.g., as illustrated in FIGS. 4A and 4C, or method C) for chroma components of a current block. In some approaches, the same set of intra modes in a predefined intra mode list is used across different reference lines (e.g., the predefined intra mode list is unified across different reference lines). In contrast, in the methods and systems described herein, decoder side gradient-based mode derivation derives additional intra modes for each reference line that may be different across different reference lines, allowing the intra modes in the intra mode list to be more diverse, which may provide better coding efficiency.

In some embodiments, a list of reference line and intra mode combination before sorting (e.g., sometimes referred hereinafter as “list C”) has a length L=M*R, where M corresponds to the length of the predefined intra mode list (e.g., sometimes referred hereinafter as “list A”), and R corresponds to the length of a predefined list of allowed reference lines (e.g., sometimes referred hereinafter as “list B”). After sorting the template-based costs for the list of reference line and intra mode combination, the first S entries in the sorted list are selected to be used.

In some approaches, intra prediction explores spatial redundancy between a current block and its neighboring samples. Conventionally, intra prediction modes can be classified as directional and non-directional modes, indicating their directional or non-directional correlation between neighboring reference blocks and current block. Examples of non-directional intra prediction mode include planar mode and DC mode.

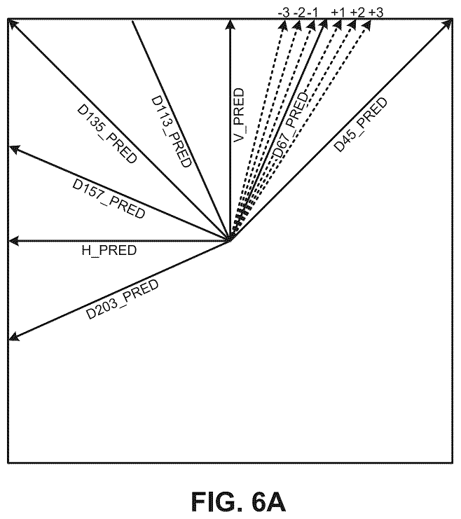

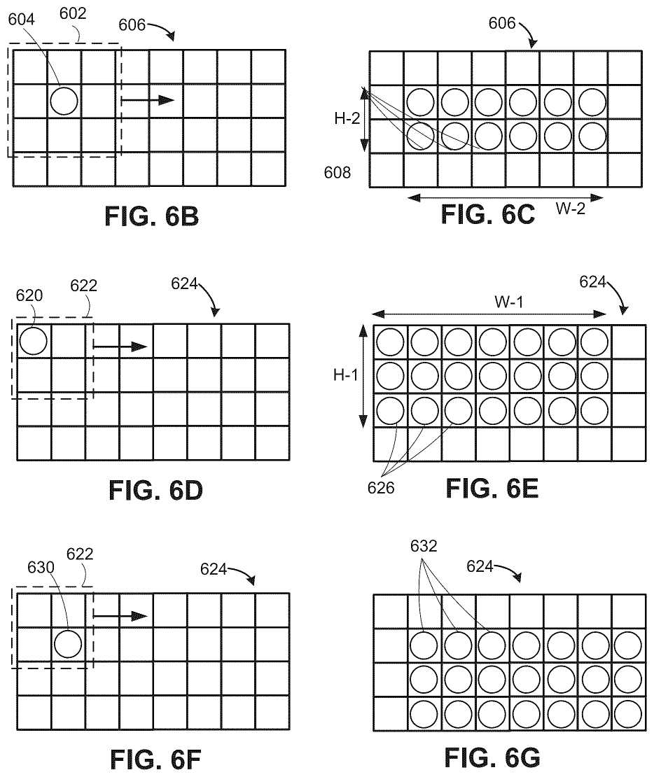

In some systems, an intra prediction mode is explicitly signaled and its corresponding prediction signal is generated using an interpolation filter applied on reference samples. The intra modes include both directional and non-directional prediction modes as shown in FIG. 6A. The directional prediction mode includes, for example, D45_PRED, V_PRED, H_PRED, and D203_PRED. Non-directional prediction modes include planar and DC mode. A mode specific intra predictor for the whole coding block is generated based on the directional or non-directional texture characteristics of the current block.

In some embodiments, one or more simplified edge filters are used in the gradient-based intra mode derivation method to derive a conventional intra prediction mode when a non-conventional intra prediction mode is applied for the prediction of the current block. In some embodiments, the derived intra prediction mode is used to determine the intra mode used in other coding stages. The non-conventional intra prediction mode includes, for example, a predictor generated by matrix-multiplication, or an extrapolation model, or an intra block copy pointed by a block vector, or a fused predictor formed using at least two predictors, each predictor corresponding to one conventional intra mode. The other coding stages include, for example, predicting chroma components from collocated luma components using direct mode, building a most probable mode list for mode propagation, and/or selecting a transform kernel.

In some approaches, non-conventional intra prediction modes may be generated by matrix-based multiplication. The multiplication is performed by the reference samples of a current coding block and some training-based coefficients stored in a matrix. An intra predictor could also be generated by an intra block copy with a block vector pointing to its reference area in a predefined search area. An intra predictor could also be generated by an extrapolation model, where the predicted samples are extrapolated from neighboring reference samples. In this mode, the intra predictor is generated sample by sample in a predefined generation order. A newly generated sample may be used as a new input to the extrapolation model to generate a subsequential sample the predefined generation order iterates through the whole coding block. Such non-conventional intra prediction modes complement the prediction methods in a codec when a current coding block shows no obvious directional texture or planar texture as defined in conventional intra prediction methods.

The intra prediction mode is not only used at a prediction stage to define an intra predictor but is also used in other coding stages to determine related codec information. For example, multiple primary (or secondary) transform kernel sets are selected based on the conventional intra prediction mode. In another example, when predicting chroma components from luma components, a direct mode that reuses the convention intra mode information of the collocated luma component may be used to generate the chroma intra predictor. As another example, for intra mode propagation, the conventional intra mode information of neighboring coding block is used to build a Most Probable Mode (MPM) list. The intra mode of the current block uses one of the modes within the MPM to generate the prediction signal.

When a coding block is predicted using a non-conventional intra prediction mode, it may be difficult to define a conventional intra prediction mode for coding stages, such as transform kernel selection, direct mode application (for chroma), or intra mode propagation.

In some embodiments, decoder-side gradient-based intra mode derivation is used to determine the conventional intra mode information for some of the non-conventional intra prediction mode. This gradient-based intra mode derivation method generates a histogram of gradients using the prediction samples of the current block. Based on the histogram, the top gradient is mapped to one conventional intra mode.

The gradient is calculated based on a 3×3 sample window, as shown in FIG. 6B. A horizontal (Fₓ) and a vertical (F_{y}) Sobel filter are applied on this 3×3 window for the considered predicted sample (samples) to derive its horizontal gradient (Gₕₒᵣ) and vertical gradient (Gᵥₑᵣ), respectively. The Sobel filters Fₓ and F_{y} for edge detection are defined as:

$${F}_{x} = [ \begin{matrix}- 1 & - 2 & - 1 \\ 0 & 0 & 0 \\ 1 & 2 & 1\end{matrix} ] {F}_{y} = [ \begin{matrix}1 & 0 & - 1 \\ 2 & 0 & - 2 \\ 1 & 0 & 1\end{matrix} ]$$

Subsequently, an angle gradient descriptor Dₛ for the sample is computed based on the following equation:

$${D}_{s} = \{ \begin{matrix}tan {θ}^{s} = \frac{{G}_{ver}^{s}}{{G}_{hor}^{s}} & if {G}_{ver} > {G}_{hor} \\ cot {θ}^{s} = \frac{{G}_{hor}^{s}}{{G}_{ver}^{s}} & if {G}_{ver} \leq {G}_{hor}\end{matrix}$$

The computed Dₛ descriptor maps the direction θ to a closest corresponding conventional intra mode. To build a histogram, a window 602 loops over a current block 606 in raster scan order at circled positions of samples 608 as shown in FIG. 6C. Due to the 3×3 window filter shape of the window 602, the width and the height of samples 608 considered for building the histogram are (W−2) and (H−2), respectively. W and H are the original width and height of the current block 606. For example, in FIGS. 6B-6G, W=8 and H=4.

In some embodiments, a simplified horizontal Fₓ and a simplified vertical edge filter F_{y} are applied on a 2×2 window and defined as follows:

$${F}_{x} = [ \begin{matrix}- 1 & - 1 \\ 1 & 1\end{matrix} ] {F}_{y} = [ \begin{matrix}1 & - 1 \\ 1 & - 1\end{matrix} ]$$

In some embodiments, the position of a selected sample 620 (or samples) in a 2×2 window 622 corresponds to the top-left sample, as shown in FIG. 6D. Accordingly, samples 626 considered for a histogram have width of (W−1) and height of (H−1), where W and H are the original width and height of a current block 624, as shown in FIG. 6E.

In some embodiments, the position of a considered sample 630 (or samples) in the 2×2 window 622 corresponds to other positions, e.g. a bottom-right position as shown in FIG. 6F. Accordingly, samples 632 considered for the histogram have width of (W−1) and height of (H−1), where W and H are the original width and height of the current block 624, as shown in FIG. 6G.

In some embodiments, the one or more simplified edge filters are applied adaptively based on other coding information. For example, when a size of a coding block is smaller than a threshold (e.g. 64 samples), simplified edge filters are applied. Otherwise, original Sobel filters are applied. In some embodiments, the described edge filter is adaptively applied based on a prediction mode of the current block. For example, to increase the coverage of the samples in the current block that are considered for determining the histogram. In some embodiments, different edge filters are used to inter mode and for intra mode. In some embodiments, intra mode information is generated for a current block that is inter coded and the generated intra mode information is used for other coding purposes or other coding stages.

In some embodiments, the application of the one or more simplified edge filter is explicitly signaled in a bitstream at a picture, sub-picture, slice, CTU, or CU level.

In some embodiments, the samples considered for constructing the histogram are adaptively determined based on other coding information. In some embodiments, a threshold is determined based on a size of a current coding block. When the number of samples considered is smaller than the threshold, a 2×2 window as described with reference to FIGS. 6C-6F loops over a current block. Otherwise, the histogram is built with the number of considered samples at the threshold. For example, the constructing of histograms is stopped when the threshold is reached.

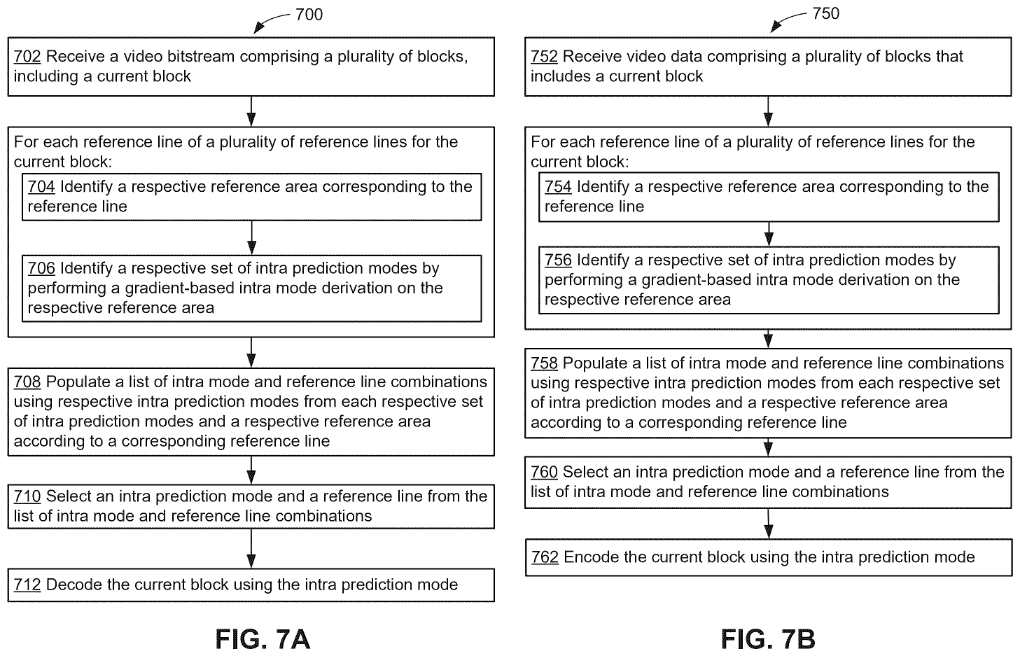

FIG. 7A is a flow diagram illustrating a method 700 of decoding video in accordance with some embodiments. The method 700 may be performed at a computing system (e.g., the server system 112, the source device 102, or the electronic device 120) having control circuitry and memory storing instructions for execution by the control circuitry. In some embodiments, the method 700 is performed by executing instructions stored in the memory (e.g., the memory 314) of the computing system.

The system receives (702) a video bitstream (e.g., a coded video sequence) comprising a plurality of blocks (e.g., corresponding to one or more frames), including a current block. For each reference line of a plurality of reference lines for the current blocks: the system identifies (704) a respective reference area corresponding to the reference line; and the system identifies (706) a respective set of intra prediction modes by performing a gradient-based intra mode derivation on the respective reference area. The system populates (708) a list of intra mode and reference line combinations using respective intra prediction modes from each respective set of intra prediction modes and a respective reference area according to a corresponding reference line. The system selects (710) an intra prediction mode and a reference line from the list of intra mode and reference line combinations. The system decodes (712) the current block using the intra prediction mode. In this way, one or more edge filters are used in a gradient-based intra mode derivation method to derive a conventional intra prediction mode when a non-conventional intra prediction mode is applied for the prediction of the current block.

In some embodiments, the unified predefined intra mode list used across different reference lines in template cost-based intra prediction for decoder side gradient-based mode derivation (e.g., method C) is extended with additional N intra modes. The N intra modes correspond to the top N intra modes derived from the decoder side gradient-based mode derivation method per reference line. The extended intra mode list has a length of M+N entries, and a length L′ of the list of reference line and intra mode combinations equal to L′=(M+N)*R. The extended N intra modes are derived per reference line and may be different for each reference line. In some embodiments, M=8 intra modes are included in list A. In some embodiments, N=5 extended intra modes.

In some embodiments, the number S is unchanged, e.g., the number of allowed combinations after the sorting process is unchanged. In some embodiments, even when the same number of combinations are used, the methods and systems described herein add diversity to the list of intra modes. In some embodiments, the number of allowed combinations S is increased.

In some embodiments, the allowed reference line using decoder side gradient-based mode derivation is {1,3,5}, wherein the number indicates the reference line index, and hence R=3.

In some embodiments, the building of the predefined intra mode list that is unified across different reference lines in method C is modified to include N intra modes. The N intra modes corresponds to the top N intra modes derived from the decoder side gradient-based mode derivation method for each reference line. In some embodiments, the length of the predefined intra mode list is kept unchanged, e.g., having M (M>N) entries.

In some embodiments, a size of the template (e.g., L1 and L2 in FIG. 4A) used in the gradient-based intra mode derivation is different from that illustrated in FIG. 4A (e.g., different aspect ratio between L1 and L2, or in another aspect). In some embodiments, a template of current block (e.g., a left template 554 and/or an above template 556) is extended to double of the width W and double of the height H of a current block 552, as shown in FIG. 5B. Furthermore, in some embodiments, the size of the left template 554 and the above template 556 are different (e.g., T1 is not equal to T2). Such an approach may provide flexibility by allowing the above template 556 and the left template 554 to be different, and may better capture the texture of the samples.

In some embodiments, a flag is signaled in the bitstream to indicate the usage of the disclosed methods. In some embodiments, an index i (i<S) is further signaled to indicate which entry in the sorted list is used.

In some embodiments, the cost of SATD used for sorting may be changed to other metrics, such as SAD, (Mean Removal) MR-SAD, or another metric.

FIG. 7B is a flow diagram illustrating a method 750 of encoding video in accordance with some embodiments. The method 750 may be performed at a computing system (e.g., the server system 112, the source device 102, or the electronic device 120) having control circuitry and memory storing instructions for execution by the control circuitry. In some embodiments, the method 750 is performed by executing instructions stored in the memory (e.g., the memory 314) of the computing system. In some embodiments, the method 750 is performed by a same system as the method 700 described above.

The system receives (752) video data (e.g., a source video sequence) comprising a plurality of blocks that includes a current block. For each reference line of a plurality of reference lines for the current block: the system identifies (754) a respective reference area corresponding to the reference line and the system identifies (756) a respective set of intra prediction modes by performing a gradient-based intra mode derivation on the respective reference area. The system populates (758) a list of intra mode and reference line combinations using respective intra prediction modes from each respective set of intra prediction modes and a respective reference area according to a corresponding reference line. The system selects (760) an intra prediction mode and a reference line from the list of intra mode and reference line combinations. The system encodes (762) the current block using the intra prediction mode. In some embodiments, the system encodes the current block using information of one or more syntax elements. In some embodiments, the system transmits the one or more encoded syntax elements and the encoded current block via a video bitstream. As described previously, the encoding process may mirror the decoding processes described herein (e.g., using multiple reference lines for decoder side gradient-based mode derivation with template cost-based intra prediction). For brevity, those details are not repeated here.

Although FIGS. 7A and 7B illustrate a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

(A1) In one aspect, some embodiments include a method (e.g., the method 700) of video decoding. In some embodiments, the method is performed at a computing system (e.g., the server system 112) having memory and control circuitry. In some embodiments, the method is performed at a coding module (e.g., the coding module 320). In some embodiments, the method is performed at a source coding component (e.g., the source coder 202), a coding method includes (i) receiving a video bitstream comprising a plurality of blocks, including a current block; (ii) for each reference line of a plurality of reference lines for the current block: identifying a respective reference area corresponding to the reference line; and identifying a respective set of intra prediction modes by performing a gradient-based intra mode derivation on the respective reference area; (iii) populating a list of intra mode and reference line combinations using respective intra prediction modes from each respective set of intra prediction modes and a respective reference area according to a corresponding reference line; (iv) selecting an intra prediction mode and a reference line from the list of intra mode and reference line combinations; and (v) decoding the current block using the intra prediction mode. In this way, a unified predefined intra mode list across different reference lines is extended with N intra modes. The N intra modes may correspond to the top N intra modes derived from the decoder side gradient-based mode derivation method per each reference line. The extended intra mode list may have a length of M+N entries, where M indicates the length of the predefined intra mode list. This makes the length of list of reference line and intra mode combinations equal to L′=(M+N)*R. Because the extend N is derived per reference line, they might be different for each reference line.

(A2) In some embodiments of A1, the current block is a chroma block. In some embodiments, a combination of multiple reference lines and gradient-based intra mode derivation is applied to chroma blocks only. In some embodiments, the combination is applied to one or more luma blocks (e.g., in addition to one or more chroma blocks).

(A3) In some embodiments of A1 or A2, the list of intra mode and reference line combinations further comprises one or more intra prediction modes identified without performing any gradient-based intra mode derivation. For example, M=8 intra modes may be included in combined list.

(A4) In some embodiments of any of A1-A3, selecting respective intra prediction modes from each respective set of intra prediction modes comprises selecting five intra prediction modes. For example, N=5 intra modes are added to the combined list.

(A5) In some embodiments of any of A1-A4, the method further comprises, sorting each respective set of intra prediction modes prior to selecting the respective intra prediction modes. For example, the number of entries, S, in the combined list is unchanged, e.g., the allowed combination after sorting is unchanged. As another example, the number of allowed combinations, S, is increased.

(A6) In some embodiments of A5, the sorting is performed based on an associated cost. For example, the cost may be a sum of absolute transform difference (SATD) cost. However, the cost of SATD used for sorting might be changed to other metrics, such as SAD, (Mean Removal) MR-SAD, or the like.

(A7) In some embodiments of any of A1-A6, the plurality of reference lines consists of three reference lines.

(A8) In some embodiments of A7, the three reference lines are non-adjacent. For example, the allowed reference line using decoder side gradient-based mode derivation is {1,3,5}, where the number indicates the reference line index, and hence R=3.

(A9) In some embodiments of any of A1-A8, the list of intra mode and reference line combinations has a predefined size. For example, building the predefined intra mode list may be unified across different reference line to include N intra modes. The N intra modes corresponds to the top N intra modes derived from the decoder side gradient-based mode derivation method per each reference line. The length the predefined intra mode list is kept unchanged, i.e. having M (M>N) entries.

(A10) In some embodiments of any of A1-A9, two or more respective reference areas for two or more reference lines have varying shapes. For example, a template size might be different from the size shown in FIG. 4B.

(A11) In some embodiments of any of A1-A10, the respective reference area has a dimension that is double a corresponding dimension of the current block. For example, the template of current block might be extended to double of the width and double of the height of the current block, as shown in FIG. 5B. In some embodiments, an above portion of the template is a different size than a left portion of the template. For example, the size of left and above template may be different (e.g., T1!=T2).

(A12) In some embodiments of any of A1-A10, the method further comprises parsing a flag from the video bitstream, the flag indicating whether to perform the gradient-based intra mode derivation for each reference line of the plurality of reference lines. For example, whether the above method is used is determined from a flag signaled in the bitstream.

(A13) In some embodiments of any of A12, the method further comprises further comprising parsing an index from the video bitstream, the index indicating a size of the list of intra mode and reference line combinations. For example, an index i (i<S) is signaled to indicate which entries in the sorted list is used.

(A14) In some embodiments of any of A1-A13, performing the gradient-based intra mode derivation comprises applying an edge filter to samples of the reference area. For example, one or more simplified edge filters is/are used in the gradient-based intra mode derivation method to derive a conventional intra prediction mode when a non-conventional intra prediction mode is applied for the prediction of the current block. In some embodiments, whether to apply the edge filter is signaled in the video bitstream. For example, the application of one or more simplified edge filter is explicitly signaled in bitstream at a picture, sub-picture, slice, CTU, and/or CU level. In some embodiments, the edge filter is a horizontal or vertical edge filter.

(A15) In some embodiments of A14, a window for the edge filter is determined based on coding information. For example, the considered samples for building histogram are adaptively determined based on other coding information. As an example, a threshold is determined based on the current coding block size. When the number of considered samples is smaller than this threshold, a 2×2 window as described above loops over current block; otherwise, the histogram is built with the number of considered samples to the threshold.

(A16) In some embodiments of A14 or A15, the edge filter is applied when a non-conventional intra prediction mode is used for the current block. The non-conventional intra prediction mode includes but not limited to predictor generated by matrix-multiplication, or an extrapolation model, or intra block copy pointed by a block vector, or a fused predictor using at least two predictors, each predictor corresponds to one conventional intra mode.

(A17) In some embodiments of any of A14-A16, the edge filter is selectively applied based on coding information. For example, one or more simplified edge filters is/are applied adaptively based on the other coding information. In some embodiments, the type of edge filter is selected based on coding information. For example, a Sobel filter may be applied for large blocks and a simplified edge filter may be applied for smaller blocks.

(A18) In some embodiments of A17, the coding information comprises one or more of a block size and a prediction mode. For example, when coding block size is smaller than a threshold (e.g. 64 samples), simplified edge filters are applied. Otherwise, the original Sobel filters are applied. As an example, the proposal edge filter is adaptively applied based on prediction mode.

(B1) In another aspect, some embodiments include a method (e.g., the method 750) of video encoding. In some embodiments, the method is performed at a computing system having memory and one or more processors. The method includes: (i) receiving video data comprising a plurality of blocks, including a current block; (ii) for each reference line of a plurality of reference lines for the current block: identifying a respective reference area corresponding to the reference line; and identifying a respective set of intra prediction modes by performing a gradient-based intra mode derivation on the respective reference area; (iii) populating a list of intra mode and reference line combinations using respective intra prediction modes from each respective set of intra prediction modes and a respective reference area according to a corresponding reference line; (iv) selecting an intra prediction mode and a reference line from the list of intra mode and reference line combinations; and (v) encoding the current block using the intra prediction mode.

(B2) In some embodiments of B1, the method further comprises transmitting a video bitstream that includes the encoded current block.

(B3) In some embodiments of B1 and B2, the method further includes encoding-side analogues of any of the features described above with respect to A1-A18.

(C1) In one aspect, some embodiments include a method of video decoding. In some embodiments, the method is performed at a computing system (e.g., the server system 112) having memory and control circuitry. In some embodiments, the method is performed at a coding module (e.g., the coding module 320). In some embodiments, the method is performed at a source coding component (e.g., the source coder 202), a coding engine (e.g., the coding engine 212), and/or an entropy coder (e.g., the entropy coder 214). The method includes (i) receiving a video bitstream comprising a plurality of blocks, including a current block; (ii) identifying a reference area for the current block; (iii) identifying a set of intra prediction modes by performing a gradient-based intra mode derivation on the reference area, including applying an edge filter to reference samples of the reference area; (iv) selecting an intra prediction mode from the set of intra prediction modes; and (v) decoding the current block using the intra prediction mode. In this way, one or more simplified edge filters is/are used in the gradient-based intra mode derivation method to derive a conventional intra prediction mode when a non-conventional intra prediction mode is applied for the prediction of the current block. The derived intra prediction mode may be used to determine the intra mode required by other coding stages. The derived intra prediction mode may be used to determine the intra mode required by other coding stages. The other coding stages include but are not limited to predicting chroma components from collocated luma components using direct mode or building a most probable mode list for mode propagation or selecting a transform kernel.

(D1) In one aspect, some embodiments include a method of video media bitstream generation. In some embodiments, the method is performed at a computing system (e.g., the server system 112) having memory and control circuitry. In some embodiments, the method is performed at a coding module (e.g., the coding module 320). In some embodiments, the method is performed at a source coding component (e.g., the source coder 202), a coding method includes (i) generating a video bitstream, including: for each reference line of a plurality of reference lines for a current block: (a) identifying a respective reference area corresponding to the reference line; and (b) identifying a respective set of intra prediction modes by performing a gradient-based intra mode derivation on the respective reference area; (c) populating a list of intra mode and reference line combinations using respective intra prediction modes from each respective set of intra prediction modes and a respective reference area according to a corresponding reference line; (d) selecting an intra prediction mode and a reference line from the list of intra mode and reference line combinations; and (e) encoding the current block using the intra prediction mode; and (ii) transmitting the video bitstream including the encoded current block.

In another aspect, some embodiments include a computing system (e.g., the server system 112) including control circuitry (e.g., the control circuitry 302) and memory (e.g., the memory 314) coupled to the control circuitry, the memory storing one or more sets of instructions configured to be executed by the control circuitry, the one or more sets of instructions including instructions for performing any of the methods described herein (e.g., the methods 700 and 750, as well as A1-A18, B1-B3, C1, and D1 above).

In another aspect, some embodiments include a non-transitory computer-readable storage medium storing one or more sets of instructions for execution by control circuitry of a computing system, the set(s) of instructions including instructions for performing any of the methods described herein (e.g., the methods 700 and 750, as well as A1-A18, B1-B3, C1, and D1 above). In some embodiments, a memory or non-transitory computer-readable storage medium stores a video bitstream including any of the features (e.g., syntax and encoded information) disclosed herein.

Unless otherwise specified, any of the syntax elements described herein may be HLS. As used herein, HLS is signaled at a level that is higher than a block level. For example, HLS may correspond to a sequence level, a frame level, a slice level, or a tile level. As another example, HLS elements may be signaled in a video parameter set (VPS), a sequence parameter set (SPS), a picture parameter set (PPS), an adaptation parameter set (APS), a slice header, a picture header, a tile header, and/or a CTU header.

It will be understood that, although the terms “first,” “second,” etc. may be used herein to describe various elements, these elements should not be limited by these terms. These terms are only used to distinguish one element from another. The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “when” can be construed to mean “if” or “upon” or “in response to determining” or “in accordance with a determination” or “in response to detecting” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purposes of explanation, has been described with reference to specific embodiments. However, the illustrative discussions above are not intended to be exhaustive or limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A method of video decoding performed at a computing system having memory and one or more processors, the method comprising:
receiving a video bitstream comprising a plurality of blocks, including a current block;
for each reference line of a plurality of reference lines for the current block:
identifying a respective reference area corresponding to the reference line; and
identifying a respective set of intra prediction modes by performing a gradient-based intra mode derivation on the respective reference area;
populating a list of intra mode and reference line combinations using respective intra prediction modes from each respective set of intra prediction modes and a respective reference area according to a corresponding reference line;
selecting an intra prediction mode and a reference line from the list of intra mode and reference line combinations; and
decoding the current block using the intra prediction mode.

2. The method of claim 1, wherein the current block is a chroma block.

3. The method of claim 1, wherein the list of intra mode and reference line combinations further comprises one or more intra prediction modes identified without performing any gradient-based intra mode derivation.

4. The method of claim 1, wherein selecting respective intra prediction modes from each respective set of intra prediction modes comprises selecting five intra prediction modes.

5. The method of claim 1, further comprising sorting each respective set of intra prediction modes prior to selecting the respective intra prediction modes.

6. The method of claim 5, wherein the sorting is performed based on an associated cost.

7. The method of claim 1, wherein the plurality of reference lines consists of three reference lines.

8. The method of claim 7, wherein the three reference lines are non-adjacent.

9. The method of claim 1, wherein the list of intra mode and reference line combinations has a predefined size.

10. The method of claim 1, wherein two or more respective reference areas for two or more reference lines have varying shapes.

11. The method of claim 1, wherein the respective reference area has a dimension that is double a corresponding dimension of the current block.

12. The method of claim 1, further comprising parsing a flag from the video bitstream, the flag indicating whether to perform the gradient-based intra mode derivation for each reference line of the plurality of reference lines.

13. The method of claim 12, further comprising parsing an index from the video bitstream, the index indicating a size of the list of intra mode and reference line combinations.

14. The method of claim 1, wherein performing the gradient-based intra mode derivation comprises applying an edge filter to samples of the reference area.

15. The method of claim 14, wherein a window for the edge filter is determined based on coding information.

16. The method of claim 14, wherein the edge filter is applied when a non-conventional intra prediction mode is used for the current block.

17. The method of claim 14, wherein the edge filter is selectively applied based on coding information.

18. The method of claim 17, wherein the coding information comprises one or more of a block size and a prediction mode.

19. A method of video encoding performed at a computing system having memory and one or more processors, the method comprising:
receiving video data comprising a plurality of blocks, including a current block;
for each reference line of a plurality of reference lines for the current block:
identifying a respective reference area corresponding to the reference line; and
identifying a respective set of intra prediction modes by performing a gradient-based intra mode derivation on the respective reference area;
populating a list of intra mode and reference line combinations using respective intra prediction modes from each respective set of intra prediction modes and a respective reference area according to a corresponding reference line;
selecting an intra prediction mode and a reference line from the list of intra mode and reference line combinations; and
encoding the current block using the intra prediction mode.

20. A non-transitory computer-readable storage medium storing a video bitstream that is generated by a video encoding method, the video encoding method comprising:
for each reference line of a plurality of reference lines for a current block:
identifying a respective reference area corresponding to the reference line; and
identifying a respective set of intra prediction modes by performing a gradient-based intra mode derivation on the respective reference area;
populating a list of intra mode and reference line combinations by using respective intra prediction modes from each respective set of intra prediction modes and a respective reference area according to a corresponding reference line;
selecting an intra prediction mode and a reference line from the list of intra mode and reference line combinations; and
encoding the current block using the intra prediction mode; and
wherein the video bitstream comprises the encoded current block.
